(19) United States
(12) Patent Application Publication
(10) Pub. No.: US 2023/0148007 A1
(43) Pub. Date: May 11, 2023

(54) SYSTEM AND METHOD FOR PLAYING AUDIO CORRESPONDING TO AN IMAGE

(71) Applicant: Christopher J. Nadolny, Maplewood, NJ (US)

(72) Inventor: Christopher J. Nadolny, Maplewood, NJ (US)

(21) Appl. No.: 17/523,579

(22) Filed: Nov. 10, 2021

(51) Int. Cl. G06F 16/638; G06F 3/16; G06F 3/0482; G06K 9/00

(52) U.S. Cl. CPC G06F 16/639; G06F 3/165; G06F 3/0482; G06K 9/00664

(57) ABSTRACT

A computer-implemented method (200) or system has a device for playing an audio selection corresponding to an image. The method comprises capturing (202) the image by a camera of a user device which is associated with a user profile. The captured image is scanned (204) to extract one or more visual data corresponding to the captured image. The one or more visual data is sent (206) to the server though the network. The server then recognizes (208) the image information corresponding to the image using the one or more visual data. One or more audio selection is searched (210) by the server based on the image information, the one or more visual data and the user profile. A list comprising the one or more audio selection is displayed (212) on the user device. The user then receives (214) audio data corresponding to the list of the one or more audio selection and the audio selection from the one or more audio selection is played by the user device.

### BACKGROUND OF THE INVENTION

### 1. Field Of The Invention

The present invention generally relates to a system and a method for image recognition; and more particularly, to a system and method for recognizing images, searching and playing appropriate music associated with the image based on a plurality of factors.

### 2. Description Of The Prior Art

Art appreciation includes a number of factors, such as the visual aspects of the art itself along with the surrounding circumstances in which a piece of art is viewed. Music or other audio clues could significantly improve and even change the way a viewer understands the deeper or alternate meanings of art. People could experience different emotions while interacting with art along with ambient music.

Today most art aficionados utilize electronic devices such as mobile phones, tablet computers, and the like on a regular basis and usually carry around such devices with them.

Such electronic devices comprise image capturing mechanisms such as an array of cameras, various computing processors and are also connected to the internet. While viewing a piece of art like a painting or a sculpture, a viewer may wish to search for information related to the art and also listen to music while appreciating the art.

Various audio players exist that are often provided to visitors of a monument, art gallery, or museum for the assistance of the visitors. Such audio players store pre-recorded instructions or details related to a particular artistic work that enhances the viewer experience. However, there does not exist any methods or device for providing a wholesome experience designed particularly for an individual based on his personal attributes along with the visual features of the art. Audio player devices are expensive and need to be maintained by the authorities managing the art galleries etc. The existing mechanisms are unable to address the issue of providing a holistic experience of art that is personalized for each individual experiencing the art without the requirement of an additional device that needs to be purchased and maintained.

Accordingly, there exists a need for a method and system wherein an electronic device owned by the viewer enables searching and playing suitable audio selections or music that is personalized for each individual to deliver a wholesome experience while observing an artistic creation.

### SUMMARY OF THE INVENTION

It will be understood that this disclosure is not limited to the particular systems and methodologies described, as there can be multiple possible embodiments of the present invention which are not expressly illustrated in the present disclosure. It is also to be understood that the terminology used in the description is for the purpose of describing the particular versions or embodiments only, and is not intended to limit the scope of the present invention.

Embodiments of the present invention provide methods, systems, devices, and processor-executable instructions for playing an audio selection corresponding to an image. The present invention discloses methods implemented by unique hardware constructions enabling a user to view artistic creations along with suitable audio selections such as ambient music or any other genre-specific music.

In an embodiment, a computer-implemented method for playing an audio selection corresponding to an image is described. The method is implemented in a processing device communicably connected to a server and one or more user devices through a network. The method comprises the steps of capturing the image by a camera of a user device from one or more user devices, each of the user devices being associated with a corresponding user profile. The captured image is scanned to extract one or more visual data corresponding to the captured image. The one or more visual data are sent to the server through the network. Image information corresponding to the image is recognized by the server using the one or more visual data. The server searches for one or more audio selection based on the image information, the one or more visual data and the user profile.

In an aspect, the one or more audio selection is searched from a pre-created audio playlist database associated with the user profile. In a related aspect, the pre-created audio playlist database comprises one or more audio selection aggregated based on genre information.

Then, a list comprising the one or more audio selection searched on the user device is displayed on the user device. Finally, the audio data corresponding to the list of the one or more audio selections is received by the user device, and then the audio selection from the one or more audio is played by the user device.

In another embodiment, a system for playing an audio selection corresponding to an image is described. The system comprises one or more user devices, one or more servers, one or more databases communicatively connected to the one or more servers, and a network for connecting the user devices with the one or more servers. Each of the one or more devices is associated with a corresponding one or more user profiles. The one or more user devices comprise one or more processors, a display screen, an audio output unit, and a camera. The user device is enabled to capture an image by using the camera. The camera may further be connected with the one or more processors and the display screen for transferring the captured image and image-related data. The one or more servers are communicatively coupled with the one or more user devices through a network. The user device is configured to scan the captured image to extract one or more visual data corresponding to the captured image and send the one or more visual data to the server through the network. The server is configured to recognize image information corresponding to the image using the one or more visual data, and search for one or more audio selections based on the image information, the one or more visual data, and the associated user profile.

In an aspect, the one or more audio is searched from a pre-created audio playlist database associated with the user profile. In a related aspect, the pre-created audio playlist database comprises one or more audio aggregated based on genre information.

The server is further configured to send or transmit a list comprising the one or more searched audio along with audio data to the user device. The user device, upon receiving the list comprising the one or more audio selections, is configured to display the list of the one or more audio selections, and play the audio selection from the one or more audio selections in the list.

In yet another embodiment, a computer-readable storage device bearing computer-executable instructions is described. Such computer-executable instructions when executed on a computing system comprising at least a processor, carry out a computer-implemented method for playing an audio selection corresponding to an image. The method comprises (i) capturing the image by a camera of a user device from the one or more user devices, wherein the user device is associated with a user profile; (ii) scanning the captured image to extract one or more visual data corresponding to the captured image; (iii) sending the one or more visual data to the server through the network; (iv) recognizing, by the server, image information corresponding to the image using the one or more visual data; (v) searching for one or more audio selections by the server based on the image information, the one or more visual data and the user profile; (vi) displaying a list comprising the one or more audio selections searched on the user device; (vii) receiving audio data corresponding to the list of the one or more audio selections and playing audio selections from the one or more audio selections by the user device.

### BRIEF DESCRIPTION OF THE DRAWINGS

The accompanying drawings illustrate various embodiments of systems, methods, and embodiments of various other aspects of the invention. Any person with ordinary skills in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another component and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a system for playing an audio selection corresponding to an image, in accordance with an embodiment of the present invention;

FIG. 2 illustrates a method for playing an audio selection corresponding to an image, in accordance with an embodiment of the present invention;

FIG. 3 illustrates an example of capturing an image and playing a corresponding audio selection, in accordance with an embodiment of the present invention; and

FIG. 4 illustrates a server for determining one or more audio sequences related to an image, in accordance with an embodiment of the present invention.

### DETAILED DESCRIPTION OF THE INVENTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

References to “one embodiment”, “an embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

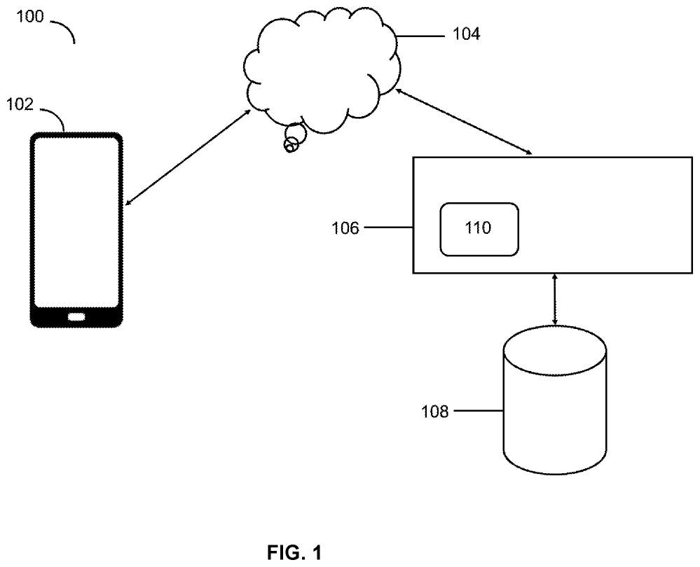

FIG. 1 illustrates a system for playing an audio selection corresponding to an image, in accordance with an embodiment of the present invention.

The system (100) comprises at least one user device (102) connected to at least one server (106) through a network. In an aspect, the user device (102) may be a smartphone, a tablet computer, a smart glass, a smart watch, and the like. The user device (102) is associated with a user profile, for example, the user device may be a smartphone with a user account that stores a profile of the user such as social network details, travel history, music and movie preferences etc. The user device (102) essentially includes one or more processors, a display screen, an audio output unit, and a camera. The user device may include various other processing and communication modules and units. The user device (102) enables a user to capture the image of an artistic work such as a painting, a sculpture, a monument, etc. by means of its camera and may be enabled to view the captured image on its display screen. Alternatively, the image may be pre-captured and stored in the user device for further analysis.

The user device (102) by means of one or more processors is enabled to scan such image of any artistic work and extract data related to various visual aspects of the art. Such visual data extracted by the user device is enabled to be transmitted to the server (106). In an aspect, there may be a plurality of servers and duplicate instances of the server for detailed processing of the received visual data. The user device may also transmit data related to the user profile associated with the user device (102).

The server (106) may include one or more processing modules (110) for processing data. In an aspect, the one or more processing modules (110) may be one or more graphics processing units. The server (106) is configured to recognize image information corresponding to the image using the one or more visual data extracted from the image of the artistic creation. In an aspect, the image information may be stored in one or more storage databases (108). The image information may include information such as the name of the artistic work, information related to the creator of the artistic work, year of the creation of the art etc. The server (106) is configured to search for one or more audio selection based on the image information, the one or more visual data, and the user profile.

In an aspect, the one or more audio selection is searched from a pre-created audio playlist database associated with the user profile. In a related aspect, the pre-created audio playlist database comprises one or more audio selection aggregated based on genre information.

The audio selection may be a song, ambient music, recorded details of the artistic work etc. The server (106) is enabled to collate one or more audio selection related to the art and create a list of audio selections. The list may comprise of the one or more searched audio selections along with audio data which is then sent to the user device. The user device (102) upon receiving the list comprising the one or more audio selection, is configured to display the list of the one or more audio selection, and play the audio selection from the one or more audio selections in the list. For example, the user of the user device (102) may be enabled to select an audio selection which is then played on the user device using the audio output unit.

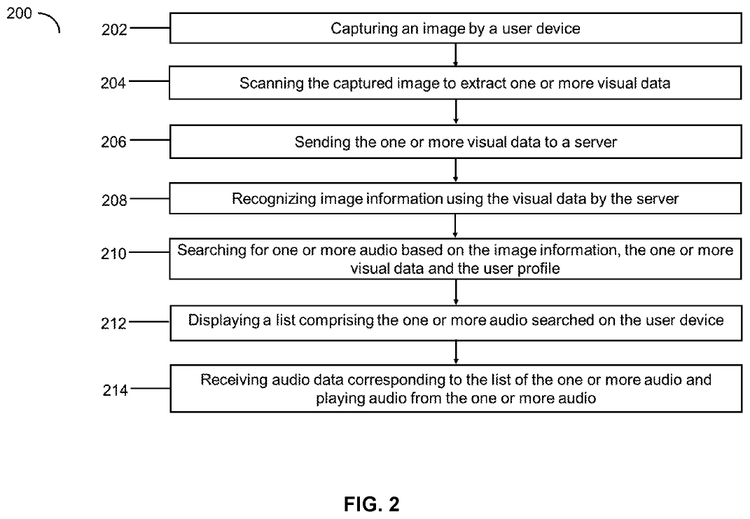

FIG. 2 illustrates a method for playing an audio selection corresponding to an image, in accordance with an embodiment of the present invention. The method may be executable on a single computing device or may be partly executed at a user end and partly at the server end. The method essentially comprises capturing (202) the image by a camera of a user device from the one or more user devices. Each user device may have an associated user profile.

The captured image is then scanned (204) to extract one or more visual data corresponding to the captured image. The one or more visual data is sent (206) to the server though the network. The server then recognizes (208) or determines image information corresponding to the image based on the one or more visual data shared by the user device. One or more audio selection is searched by the server based on the image information, the one or more visual data and the user profile. Such one or more audio selection may include one or more songs, ambient music, and the like. In an aspect, the one or more audio selection is searched from a pre-created audio playlist database associated with the user profile. In a related aspect, the pre-created audio playlist database comprises one or more audio selection aggregated based on genre information.

The list comprising the one or more audio selection is then displayed on the user device. The audio selection data corresponding to the list of the one or more audio selection is displayed on the user device and accordingly played on the user device.

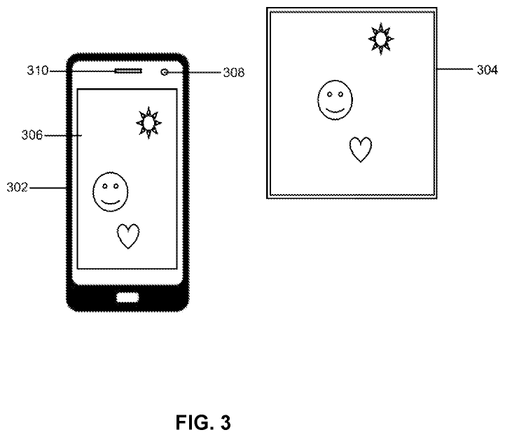

FIG. 3 illustrates an example of capturing an image and playing a corresponding audio selection, in accordance with various embodiments. A user device (302) such as a mobile phone is illustrated having a display (306), a speaker unit (310), and an image capturing unit (308). The user device (302) may also include one or more modules for communication with one or more servers, and one or more memory means for storing data permanently or a fixed time period or for a certain occurrence. Though FIG. 3 shows a portable communication device, it should be understood that various other types of electronic devices that are capable of determining and processing input can be used as well in accordance with various embodiments. These devices may include, notebook computers, personal data assistants, e-book readers, cellular phones, video gaming consoles or controllers, smart televisions, set top boxes, a wearable computer (e.g., a smart watch or glasses), and portable media players, among others. The user device (302) is enabled to capture an image of a painting (304) by means of the image capturing unit (308). In an aspect, the painting (304) may be a sculpture, a live artistic performance, or any other form of art or performance. While an image is captured in this embodiment, the techniques used herein may also be utilized with frames of digital video (live or stored), an image of a physical or digital image, and the like.

In an alternate aspect, the user device (302) may be enabled to open a pre-stored image to be displayed on the display (306). In another aspect, the user device may not capture and store an image of the painting (304); but rather selectively capture certain features such as color schema, hue, brightness etc. that are then communicated to a remote server for further processing. The user device upon capturing data related to the painting then transmits the data to a server and, in turn, receives an audio file or audio stream data associated with the painting that is then played by means of the speaker unit (310). Alternatively, upon capturing and processing the data related to the painting an audio file stored on the user device may be played.

The image captured by the user device may be analyzed to identify and assign image descriptors (e.g., tags, labels, etc.) based on the image by means of an image analysis module. Artificial intelligence may be used for image identification and extracting data related to the image. Techniques such as region of interest identification and object recognition may be used for assigning one or more image descriptors to the image. For example, based on the recognition of a face, a celestial object, a body part, etc. various descriptors may be generated and stored in association with the image. Other data may be utilized as well to assign various descriptors, such as that which may be obtained through scene recognition, location data (e.g., location inside a museum), and the like.

In an aspect, the speaker unit may further be connected to a personal audio device such as earphones, headphones, and like for a user to personally hear the received audio selection. The user device (302) may also include processing means for image analysis and image segmentation for extracting relevant data that may or may not be transmitted to a remote server.

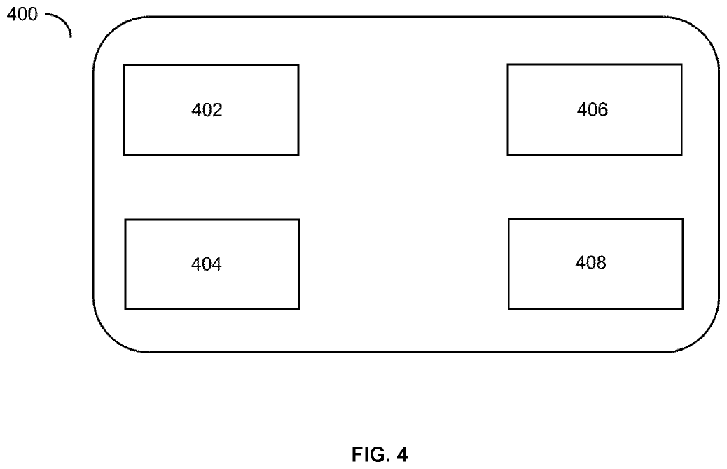

FIG. 4 illustrates a server (400) for determining one or more audio sequences related to an image, in accordance with one or more embodiments. The server (400) may include one or more processing and storage modules for effective execution of the method steps according to one or more embodiments of the present invention. The server (400) comprises an image library (402), an audio library (404), a processing module (406), and a communication module (408).

The communication module (408) enables the server (400) to send data to one or more user devices and to one or more servers, and receive data from one or more user devices and from one or more servers and databases. The server (400) is enabled to receive data related to the image captured by the user device. For example, the server may receive one or more image descriptors, or may alternatively receive the captured image itself.

The image library (402) may store an index of images along with one or more related image descriptors for identification of the painting or art captured by the user device. The server may further process the image descriptors for determining one or more second set of identifiers. Such second set of identifiers may include information related to a geographical location, an emotion, an era, and the like. These second set of identifiers determine a context and meaning of the art captured by the user device.

The audio library (404) may store an index of audio identifiers related to one or more audio files. The server utilizes the index of audio identifiers stored in the audio library (404) for determining one or more audio files related to the image captured by the user device. The audio identifiers are mapped to one or more image descriptors and the second set of descriptors. Such audio identifiers determine the audio files based on (i) the physical characteristic of the image, and (ii) the context of the image.

The server in conjunction with the audio library may further request for audio information related to the identified audio files from one or more databases storing the audio files. The server by means of the processing module (406) may retrieve, create, and identify the image descriptors, audio identifiers, and second set of descriptors. The server may create a playlist of the identified audio files along with links to respective audio files which are then transmitted to the user device for playing. Alternatively, the server may determine the audio files stored on the user device that may be suitable for play.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be construed as providing broadest scope of the embodiment consistent with the principles and the novel and inventive features disclosed or suggested herein. Accordingly, the invention is anticipated to hold on to all other such alternatives, modifications, and variations that fall within the scope of the present invention and appended claims.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Moreover, although the present disclosure and its advantages have been described in detail, it should be understood that various changes, substitutions and alterations can be made herein without departing from the disclosure as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A computer-implemented method (200) for playing an audio selection corresponding to an image in a processing device communicably connected to a server and one or more user devices through a network, the method comprising:
capturing (202) the image by a camera of a user device from the one or more user devices, wherein the user device is associated to with a user profile;
scanning (204) the captured image to extract one or more visual data corresponding to the captured image;
sending (206) the one or more visual data to the server though the network;
recognizing (208), by the server, image information corresponding to the image using the one or more visual data;
searching (210) for one audio selection by the server based on the image information, the one or more visual data and the user profile, wherein the one audio selection is searched from a pre-created audio playlist database associated with the user profile and maintained by the user;
displaying (212) a list comprising the one audio selection searched on the user device; and
receiving (214) audio data corresponding to the list comprising the one audio selection and playing audio from the one audio selection by the user device.

2. (canceled)

3. The method as recited by claim 1, wherein the pre-created audio playlist database comprises one or more audio selection aggregated based on genre information.

4. A system (100) for playing an audio selection corresponding to an image, the system comprising:
one or more user devices (102) associated with one or more user profiles, each of the one or more user devices (102) comprising one or more processors, a display screen, an audio output unit and a camera, wherein the user device captures the image by the camera;
a server (106) communicatively coupled to the one or more user devices (102) through a network (104); wherein
the user device (102) is configured to scan the captured image to extract one or more visual data corresponding to the captured image, and send the one or more visual data to the server though the network;
the server (106) is configured to recognize image information corresponding to the image using the one or more visual data, search for one audio selection based on the image information, the one or more visual data, and the user profile, wherein the one audio selection is searched from a pre-created audio playlist database associated with the user profile and maintained by the user; send a list comprising the one searched audio selection along with audio data to the user device; and
the user device (102) upon receiving the list comprising the one audio selection, is configured to display the one audio selection, and play the audio selection from the one audio selection in the list.

5. (canceled)

6. The system as recited by claim 4, wherein the pre-created audio playlist database comprises one or more audio selection aggregated based on genre information.

7. The system as recited by claim 6, wherein said server creates a playlist of the identified audio files along with links to respective audio files which are then transmitted to the user device for playing the one audio selection in the list.

8. The system as recited by claim 7, wherein said server determines the audio file stored on the user device that may be suitable for play.

9. The system as recited by claim 4, wherein server (400) comprises an image library (402), an audio library (404), a processing module (406), and a communication module (408).

10. The system as recited by claim 9, wherein said communication module (408) enables the server (400) to send data to one or more user devices and to one or more servers, and receive data from one or more user devices and from one or more servers and databases.

11. The system as recited by claim 10, wherein said server (400) is enabled to receive data related to the image captured by the user device.

12. The system as recited by claim 11, wherein said image library (402) stores an index of images along with one or more related image descriptors for identification of the painting or art captured by the user device.

13. The system as recited by claim 11, wherein said server further processes the image descriptors for determining one or more second set of identifiers related to a geographical location, an emotion, or an era.

14. The system as recited by claim 13, wherein said second set of identifiers determine a context and meaning of art captured by the user device, and said server utilizes the set of audio identifiers stored in the audio library (404) for determining one audio file related to the image captured by the user device.

15. The system as recited by claim 14, wherein said set of audio identifiers are mapped to one or more image descriptors and the second set of descriptors, and said audio identifiers determine the audio file based on (i) the physical characteristic of the image, and (ii) the context of the image.

16. A computer-readable storage device bearing computer-executable instructions which, when executed on a computing system comprising at least a processor, carry out a computer-implemented method for playing an audio selection corresponding to an image, the method comprising each of the following as implemented by a processor on the computing system:
capturing (202) the image by a camera of a user device from the one or more user devices, wherein the user device is associated with a user profile;
scanning (204) the captured image to extract one or more visual data corresponding to the captured image;
sending (206) the one or more visual data to the server though the network;
recognizing (208), by the server, image information corresponding to the image using the one or more visual data;
searching (210) for one audio selection by the server based on the image information, the one or more visual data and the user profile, wherein the one audio selection is searched from a pre-created audio playlist database associated with the user profile and maintained by the user;
displaying (212) a list comprising the one audio selection searched on the user device; and
receiving (214) audio data corresponding to the one audio selection from the one audio selection by the user device.
